(19) United States
(12) Patent Application Publication
(10) Pub. No.: US 2014/0153828 A1
(43) Pub. Date: Jun. 5, 2014

(54) Method of creating a photographic mosaic

(71) Applicants: Stephan Keszler, Southampton, NY (US); Randy Weinberger, Brooklyn, NY (US); Keith Larrimore, New York, NY (US)

(72) Inventors: Stephan Keszler, Southampton, NY (US); Randy Weinberger, Brooklyn, NY (US); Keith Larrimore, New York, NY (US)

(21) Appl. No.: 13/986,649

(22) Filed: May 21, 2013

Related U.S. Application Data
(60) Provisional application No. 61/741,462, filed on Jul. 20, 2012.

(51) Int. Cl. G06T 7/00

(52) U.S. Cl. CPC G06T 7/0079
USPC 382/173

(57) ABSTRACT

This invention is directed to a method of creating a photographic mosaic, wherein a target image is recreated using a computer, comprising the steps of: creating an image library, and selecting one image in the image library to be the target image, selecting one or more images in the image library to be the source images, dividing the target image into a number of areas (squares or rectangles) of equal size, evaluating each area for luminance and assigning a luminance value for each area, evaluating the source images for luminance and assigning a luminance value for each image, re-sizing the source images to the size of the areas, and creating the photographic mosaic by placing a source image in every area of the target image by matching the luminance value of the area with the closest luminance value of a source image within a predetermined margin.

### BACKGROUND OF THE INVENTION

This application claims the benefit of U.S. Provisional Application No. 61/688,652, filed May 18, 2012, and U.S. Provisional Application No. 61/741,462, filed Jul. 20, 2012.

### FIELD OF THE INVENTION

This invention is directed to methods of creating photographic mosaics with a computer, wherein the photographic mosaic is a recreation of an image using one or more images that have been appropriately re-sized. The invention is also directed to a device for creating photographic mosaics and a storage device containing the software that allows the user to practice a method of the present invention.

### RELATED BACKGROUND

A photographic mosaic is a picture, often a photograph, which has been divided into sections or areas, which are usually equal sized and square or rectangular in shape. Each of these areas is replaced with another photograph or image that matches or closely approximates the area of the image being recreated, usually called the target image. When viewed at low magnifications or from a distance, the image as a whole appears as an approximation of the target image, while close examination reveals that the image is in fact composed of many other photographs, often hundreds or thousands of them. Often the photographic mosaic is composed of images that relate to the theme of the photographic mosaic. For example, a photographic mosaic of a car that is composed of smaller images of cars.

### SUMMARY OF THE INVENTION

This invention is directed to a method of creating a photographic mosaic, wherein a target image is recreated using a computer and at least one source image, comprising the steps of: creating an image library, wherein the image library has at least one image stored therein, selecting one image in the image library to be the target image, selecting one or more images in the image library to be the source images, processing the target image by dividing it into a number of squares or rectangles of equal size, evaluating each square or rectangle of the target image for luminance and assigning a luminance value for each square or rectangle, evaluating the source images for luminance and assigning a luminance value for each image, re-sizing the source images to the size of the squares or rectangles that the target image has been divided into, and creating the photographic mosaic by placing a source image in every square or rectangle of the target image by matching the luminance value of the square or rectangle with the closest luminance value of a source image within a predetermined margin.

The present invention is also directed to a device for creating a photographic mosaic, wherein a target image is recreated using at least one source image, comprising: a computer with software installed, wherein the software creates a photographic mosaic using the herein described methods.

Additionally, the present invention is also directed to a storage device comprising a means for storing software, wherein the device is computer readable and contains software that can create a photographic mosaic using the methods detailed herein.

### BRIEF DESCRIPTION OF THE DRAWING

The following drawing forms part of the specification. This drawing is to help provide a better understanding of the invention, in general, and some embodiments specifically. The drawing should not be viewed as limiting the scope of the invention, as it does not encompass all the possible embodiments.

FIG. 1 is a photographic mosaic of a clown, which is composed of numerous small source images. One particular source image of a lamb figurine has been enlarged by placing the cursor over.

FIG. 2 is a photographic mosaic of Enzo Ferrari in a red Ferrari, which is composed of numerous smaller source images, a menu of virtual buttons for manipulating the displayed image or images, and a slide control to control the degree of enlargement of the images.

FIG. 3 is the same photographic mosaic as shown in FIG. 2 (Enzo Ferrari in a red Ferrari), displayed in a grid format such that the photographic mosaic no longer resembles the target image and the source images are more easily seen, a menu of virtual buttons for manipulating the displayed images, and a slide control to control the degree of enlargement of the images.

### DETAILED DESCRIPTION OF THE INVENTION

This invention is directed to a method of creating a photographic mosaic, wherein a target image is recreated using a computer and at least one source image, comprising the steps of: creating an image library, wherein the image library has at least one image stored therein, selecting one image in the image library to be the target image, selecting one or more images in the image library to be the source images, processing the target image by dividing it into a number of squares or rectangles of equal size, evaluating each square or rectangle of the target image for luminance and assigning a luminance value for each square or rectangle, evaluating the source images for luminance and assigning a luminance value for each image, re-sizing the source images to the size of the squares or rectangles that the target image has been divided into, and creating the photographic mosaic by placing a source image in every square or rectangle of the target image by matching the luminance value of the square or rectangle with the closest luminance value of a source image within a predetermined margin.

For the purposes of this invention the term “photographic mosaic” refers to an image that has been created by a number of images, which may or may not be the same. More specifically, a viewer of the photographic mosaic image sees an image that appears to approximate another image, often a known or iconic image, but upon closer inspection is actually a large grouping of smaller images.

For the purposes of this invention the term “image library” refers to a directory containing a collection of images that may be used either as a target image and/or as source images. The images may be contained within the any number of digital formats commonly used, for example, such as DPX, EXR, GIF, JPEG, JPEG-2000, PDF, PHOTOCD, PNG, Postscript, SVG, and TIFF. This is not an exhaustive list and one of ordinary skill in the art would know of other commonly used or appropriate image formats. Images can be scanned in or uploaded from the user's computer, and can also be imported from other websites, such as, for example Facebook®, Flickr®, and Picassa® (this not intended to be an exhaustive list), in order to create an image library.

For the purposes of this invention the term “target image” refers to an image selected by a user of the software that practices the inventive method to be re-created as photographic mosaic.

For the purposes of this invention the term “source image(s)” refers to an image or images selected by a user to be used in re-creating a target image as photographic mosaic. A photographic mosaic of a target image can be created using only one source image (since the source images may be repeated); however, for a photographic mosaic that more closely resembles the target image it is preferable to choose at least 10 source images to be used in the inventive method, more preferably is using 25 or more source images, and even more preferable is using 50 or more source images. Likewise, using at least 100 source images will better insure a closer approximation between the created photographic mosaic and the selected target image, but selecting 500 or more source images is the most preferred embodiment of the present invention. The target image itself may also be selected as a source image.

For the purposes of this invention the term “luminance” refers to a measure of the luminous intensity per unit area of light travelling in a given direction and is measured for every area in which the target image is subdivided, as well as, every source image (as a whole). The areas or images are then assigned a value, i.e. the “luminance value,” which is then used for the purposes of shading when the photographic mosaic is created. The closer the luminance values of the area in the target image and the source image to be placed in that area are to each other the better the resulting photographic mosaic will resemble the target image.

For the purposes of this invention the term “chrominance” refers to the signal used in video systems to convey the color information of the picture and is evaluated for every area in which the target image is subdivided, as well as, every source image (as a whole). The areas or images are then assigned a value, i.e. the “chrominance value,” which is then used for purposes of coloring when the photographic mosaic is created. The closer the chrominance values of the area in the target image and the source image to be placed in that area are to each other the better the resulting photographic mosaic will resemble the target image. It is also possible to create a photographic mosaic in black and white, thus chrominance would not be relevant.

For the purposes of this invention the term “predetermined margin” refers to the degree that the values being matched may differ, for example, if a luminance value of a square or rectangle of the target image is assigned the value of Y, and the predetermined margin is set at 10%, then any source image with a luminance value between the range of (Y×90%) to (Y×110%) would be an allowable match and could be placed in that square or rectangle when creating a photographic mosaic. In another embodiment the predetermined value represents how much a value can be altered to make a better match. For example, if a square or rectangle of a target image is assigned a luminance value of Y and the closest match is a source image with a luminance value of (Y×120%), i.e. the source image is brighter than desired, and the predetermined margin is set at 30%, then the source image can be dimmed by reducing it luminance. In this case the source image can be dimmed enough that its luminance value would also be Y, thus, it would now be a perfect match for the square or rectangle of the target image.

For the purposes of this invention the term “slide control” refers to a control displayed on the screen of a computer monitor or display that can be manipulated using the key board or mouse in order to allow the user to change a setting. This control can be something that can be moved from side to side, up and down, or even be made to appear as a “dial” or knob that is turned, or simply a query box that allows a user to input a value. All of which will correspond to a setting of some sort, for example the number and size of the areas in which the target image will be subdivided into. A general example of such a control that most computer users will be familiar with is a volume control, which allows a user to turn off the sound output or increase its volume to maximal output, or some level in between.

In the present invention some embodiments will display a slide control that allows the user to easily change or set the predetermined margin for luminance and/or chrominance, wherein allowing for minimal variance will result in a photographic mosaic that more closely approximates the target image and allowing for greater degree of variance will cause the resulting photographic mosaic to be less similar in appearance than the target image.

In another embodiment a slide control is displayed that allows the user to control the number of areas, i.e. squares or rectangles, which the target image will be divided into. Since the target image is of a specific size, as the number of areas increase, the areas will correspondingly become small in size and area. Thus, as the number of areas increases the resulting photographic mosaic will look smoother or appear more “high res” and is more likely to closely approximate the target image. Conversely, as the number of areas decreases, the resulting photographic mosaic will appear more block-like or “low res” and will less closely approximate the target image.

In one embodiment the preferred size is a square which measures 128×128 pixels. In another embodiment the preferred size is a rectangle which measures 128×96 pixels. This can, of course, vary depending on how the target image is sized, since this creates a multiplier effect on the target image, as one of ordinary skill in the art would understand. In one embodiment the target image is re-sized to 800×600 pixels. In another embodiment the target image is re-sized to 1200×800 pixels. Similarly, the source images can also be re-sized based upon the size of the target image.

Preferably the target image is scaled by a factor of 2 to 6, but the method is not limited to scaling only within that range. Thus, for example, if a target image is re-sized to 800×600 pixels, and then scaled by a factor of 2 the target image would be enlarged to 1600×1200. Accordingly, when a target image is enlarged by scaling it requires a greater number of source images to be used to create the photographic mosaic. Thus, in the above example, scaling a target image from 800×600 to 1600×1200 would require four times the amount of source images to create the photographic mosaic. However, to be clear, this would not require selecting more source images, just that the selected source images would have to be repeated by a factor of 4. A skilled artisan would understand that sizing and scaling of the target image and the source images are subject to limitations such as available storage, bandwidth, screen size, etc . . . , as well as the look desired by the user/creator.

Additionally, there are three different ways to perform matching a source image with an area in the target image. The first is by simply allowing the software to place the best matching source image in that area of the target image. The second method for matching a source image with an area within the target image is by allowing the software to place the best matching source image to a particular area within the target image, but thereafter not allowing that source image to be used again to all other source images have been used. Thus, the first matching will be optimal, but thereafter the matching will be less than optimal, likely becoming even less optimal until all of the source images have been used.

Alternatively, the third method of matching is where in the user can specify a minimum distance. For the purpose of this invention the term “distance” refers to the distance between two occurrences of the same source image. Thus, if the user selects the distance to be 5, then once a particular source image is placed within an area of the target image, that same source image may not be place within that distance. Thus, selecting a distance will force the software to often place source images in an area of the target image based upon less than optimal matching.

There are also multiple matching algorithms that may be used. In one embodiment the image matching is done using Haar wavelets, as described in C. Jacobs, A. Finkelstein, and D. H. Salesin, Fast Multiresolution Image Querying, Proceedings of SIGGRAPH 95, In Computer Graphics Proceedings, Annual Conference Series, 1995, which is hereby incorporated by reference.

In another embodiment the image matching is performed using a subpixel metric, wherein the algorithm used is:
if (float_image==0)
float_image=(float*)malloc(sizeof(float)*NUM_SUBPIXELS* NUM_CHANNELS);
scaled_data=scale_image(image_data, image_width, image_height, x, y, width, height,NUM_SUBPIXEL_ROWS_COLS, NUM_SUBPIXEL_ROWS_COLS);
for (i=0; i<NUM_SUBPIXELS*NUM_CHANNELS;
   ++i)float_image[i]=scaled_data[i];

For the purposes of this invention the term “computer” refers to a device that is programmable and designed to automatically carry out a sequence of arithmetic or logical operations. More specifically, it is capable of running or implementing the software that practices the present inventive method. The computer may be a personal computer, i.e. a laptop or desktop home computer, a server, or a mobile device, for example, such as a tablet (for example an iPad®), a smart phone (for example an iPhone®) or similar devices. The term computer also refers to two or more computers that are networked together. One of ordinary skill in the art would understand what is meant by network. The following are examples of networks: PAN, LAN, WAN, WLAN, VLAN, SAN, MAN, VPN, backbone networks, and private enterprise networks. Similarly, the term computer also refers to two or more computers connected via the Internet, i.e. what has become commonly known as World Wide Web.

For the purposes of this invention the term “storage device” refers to a device for recording or storing information or data, such as a computer program. Ideally the storage device is capable of being connected to a computer or is readable by a computer. Examples of devices capable of being connected to a computer are: a hard drive, a thumb drive, and Solid State Drives (SSD). Examples of devices that are computer readable are: CDs, DVDs, floppy disks and encoded microchips.

Another aspect of the present invention is that after a photographic mosaic is created, a file can be created and stored that details the location of each source image within the target images, such that by executing this file the photographic mosaic will quickly be recreated. The data creates an image map, which is relied upon when enlarging a particular source image by “mousing” over it. (i.e. the cursor is moved over a location)

In another embodiment of the present invention the photographic mosaic can be “moused” over (i.e. the cursor is moved over a location) and as the cursor moves over an area of the photographic mosaic the source image located at the area is displayed in an enlarged format such that the user can better see what images have been placed at the different locations making up the photographic mosaic.

In another embodiment of the present invention the photographic mosaic can be viewed as just a grid of images (i.e. the source images), such that photographic mosaic will no longer appear to replicate the target image, by clicking on a virtual button. Clicking the same button will change the view such that the photographic mosaic will once again appear to replicate the target image. In another embodiment of the present invention the source images that the photographic mosaic is composed of can be viewed in a large format by clicking on a virtual “zoom” button, which will enlarge a selected source image. In a more preferred embodiment of the present invention, a user can control the degree of enlargement of a source image. This can be done using a slide control or by entering a percentage. In another embodiment any photographic mosaic can be reduced to a “thumbnail” icon or image. One embodiment the photographic mosaic itself or its thumbnail can be used as a link either to a list of images which would include the target image and the selected source images that were used to create the photographic mosaic, or can be a link to a slide show of the target image and the selected source images used to create the photographic mosaic.

In another embodiment of the present invention, a photographic mosaic, or a thumbnail thereof, can be sent via e-mail to a recipient or posted to a social networking site (such as Facebook®), who can view the photographic mosaic, and can also view the target image and the source images, either individually, or as a slide show via a link to the computer or computer network on which the software of the present invention is being run. In another embodiment of this invention, photographic mosaics composed of up to 1000 images may be sent in such a way as to allow the receiver to obtain all 1000 source images.

Additionally, the present method may be practiced as part of a social website, wherein third parties my join the website as users, create profiles, up-load their photographs and/or images and create photographic mosaics. Guests to such a social website would be able to view any photographic mosaics, target images and source images that any user has designated as “public,” whereas images and photographic mosaics that have been designated “private” would not be viewable by guests or even other users, unless they have been designated as a “friend.” Alternatively, a user could designate some images or a library of images to be viewable by a discreet group of users by specifying which other users may view them.

In another embodiment of the present invention, the social website can have a page that contains photographic mosaics created by users and/or photographic mosaics used for promotions which have been selected by the administrator. In a more preferred embodiment, the above-mentioned page would also display news and other content controlled by the administrator, and the content could be refreshed or updated at regular time periods. Preferable time periods for refreshing the content of this page include 5 minutes, 10 minutes, 15 minutes and 30 minutes.

For the purposes of this invention the term “friend” refers to a feature wherein a registered user may search for and invite a second registered user to become a “friend” on the system. If the second user confirms the request, the two users will have special privileges that are not available to two users who are not friends. Among other things, friends on the system may collaborate on or “co-create” photograph mosaics by sharing picture libraries. Friends may also view non-public or private photograph mosaics.

For the purposes of this invention the term “liked” refers to a feature wherein a registered users may tag photograph mosaics created by other users that they admire or enjoy as “liked.” The system keeps track and displays the number of “likes” each photograph mosaic has accumulated.

In another embodiment of the present invention is where registered users may add comments associated with each photograph mosaic, whether that particular user created the photograph mosaic or not. The comments will be visible to all users, whether they are registered or not. Each comment is attributed to the user that made the comment with a link to that user's profile page. The owner or creator of the photograph mosaic may erase any and all comments associated with said photograph mosaic. A comment may also be erased by its creator.

Photographic mosaics can also be used in or as advertisements. In one embodiment of the present inventive method, an advertisement, for a business, such as, for example a retailer, a publisher or a gallery, can include a photographic mosaic of an article for sale (such as a pair of shoes, an article of clothing, a publication or a painting), wherein the photographic mosaic is composed of a target image of a specific product and source images of other products, which of course can be individually viewed by moving the cursor over the photographic mosaic. Alternatively, the photographic mosaic can be “clicked on” to direct the viewer to the advertiser's website displaying the various articles for sale. The articles for sale may be displayed together, individually, or in a slideshow.

Another aspect of the present invention is that a photographic mosaic can be “co-created” by two or more users on a social website, as described herein. A first user would create a library of images and then designate the library such that it may be shared with specific other users. A second user, who was specifically designated by the first user, may then view the library and even add images to the library. Thereafter, either the first or second user can create photographic mosaics utilizing the images stored in the library, wherein the photographic mosaics created by either user will also be viewable by either user.

In another embodiment of the present invention, a photographic mosaic, whether created individually or co-created as described herein, can be e-mailed to others, such that the recipients of the e-mail can “click-on” the photographic mosaic and be directed to a webpage containing the photographic mosaic, wherein the recipient of the e-mail can view the target image and source images through a slideshow or by “mousing” over the photographic mosaic, as described herein. A similar embodiment of the present invention is where an advertisement containing a photographic mosaic is e-mailed to members of the public, who can click-on the photographic mosaic and be directed to the retailer's website, where articles for sale can be displayed together, individually, or in a slideshow.

In another embodiment of the present method, a user can “up-load” or “post” a photographic mosaic that they have created to another social website, which would allow the viewer of the webpage to “click-on” the photographic mosaic and be thereby directed to the users profile or webpage that contains the target and source images that comprise the photographic mosaic, a library of images or some other related content. Again, a skilled artisan would immediately recognize that the user could be an advertiser or retailer.

In another embodiment of the present invention, the user can up-load content, such as photos and images, from other social websites, such as Facebook® or Instagram™. More preferably the user can quickly and easily up-load the content using a virtual button to selected from where the content is to be up-loaded.

In another embodiment of the present invention, the user can up-load content, such as photos and images, to other social websites, such as Facebook® or Instagram™. More preferably the user can quickly and easily up-load the content using a virtual button to selected where the content is to be up-loaded.

### DETAILED DESCRIPTION OF THE DRAWINGS

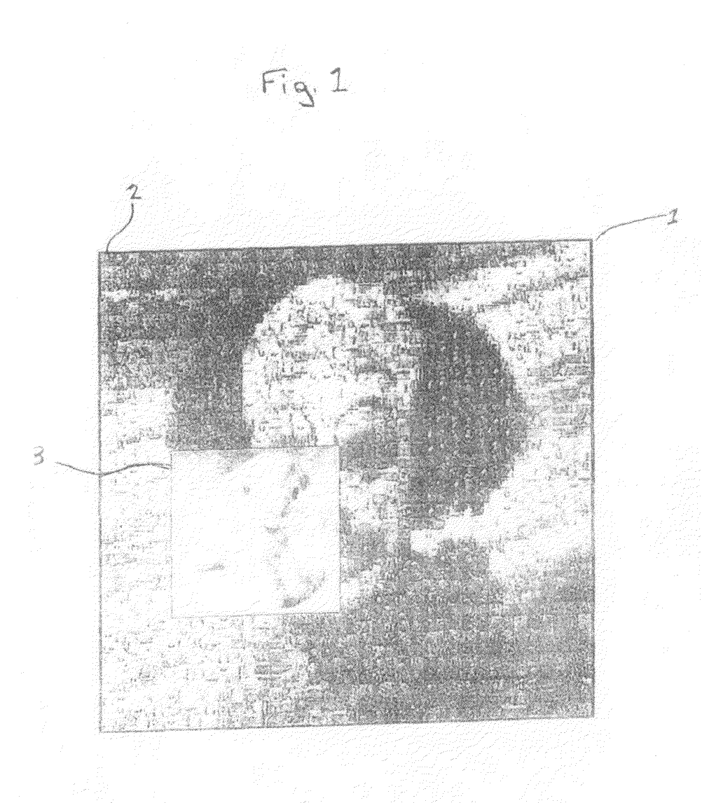

FIG. 1 is a photographic mosaic 1 of a clown, which is composed of numerous smaller source images 2. One particular source image 3 of a lamb figurine has been enlarged by placing the cursor over the location it occupies within the photographic mosaic (i.e. “mousing” over it) to allow a user to better view the individual source image in greater detail. Clicking on any source image within the photographic mosaic itself will cause the individual source image clicked on will be enlarged. In one embodiment, when a photographic mosaic is displayed also displayed is a button that will initiate a slide show of all of the images used to create the photographic mosaic (both the target and source images).

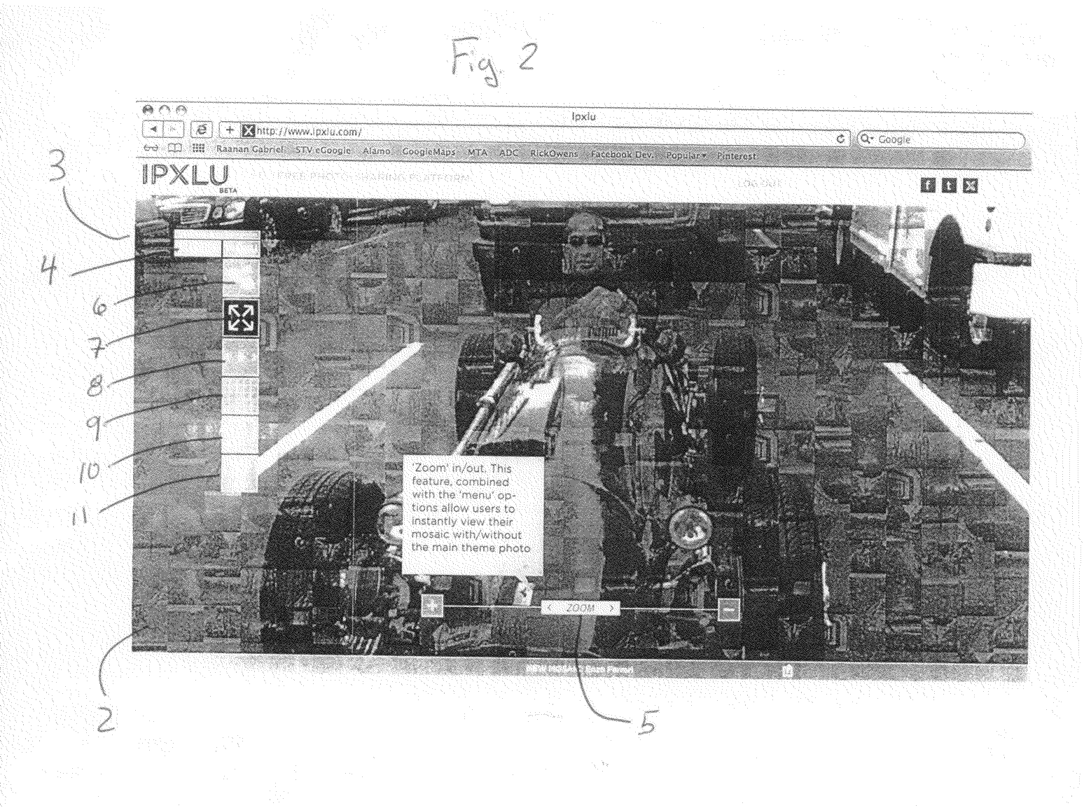

FIG. 2 is a photographic mosaic 3 of Enzo Ferrari in a red Ferrari, which is composed of numerous smaller source images 2, a menu 4 of virtual buttons for manipulating the displayed image or images, and a slide control 5 to control the degree of enlargement of the images. The menu contains a virtual button 6 for sharing the photographic mosaic and the source images with other websites, such as Facebook® or Instagram™, a virtual button 7 for enlarging the photographic mosaic to encompass the full screen (as shown), a virtual button 8 for turning on or off a slide show, a virtual button 9 for toggling the grid view on and off, a virtual button 10 for toggling on and off an enlargement mode where an image will be automatically enlarged when the cursor is “moused” over it, and a virtual button 11 for down loading images. In this figure, the full screen enlargement view has been turned on using virtual button 7.

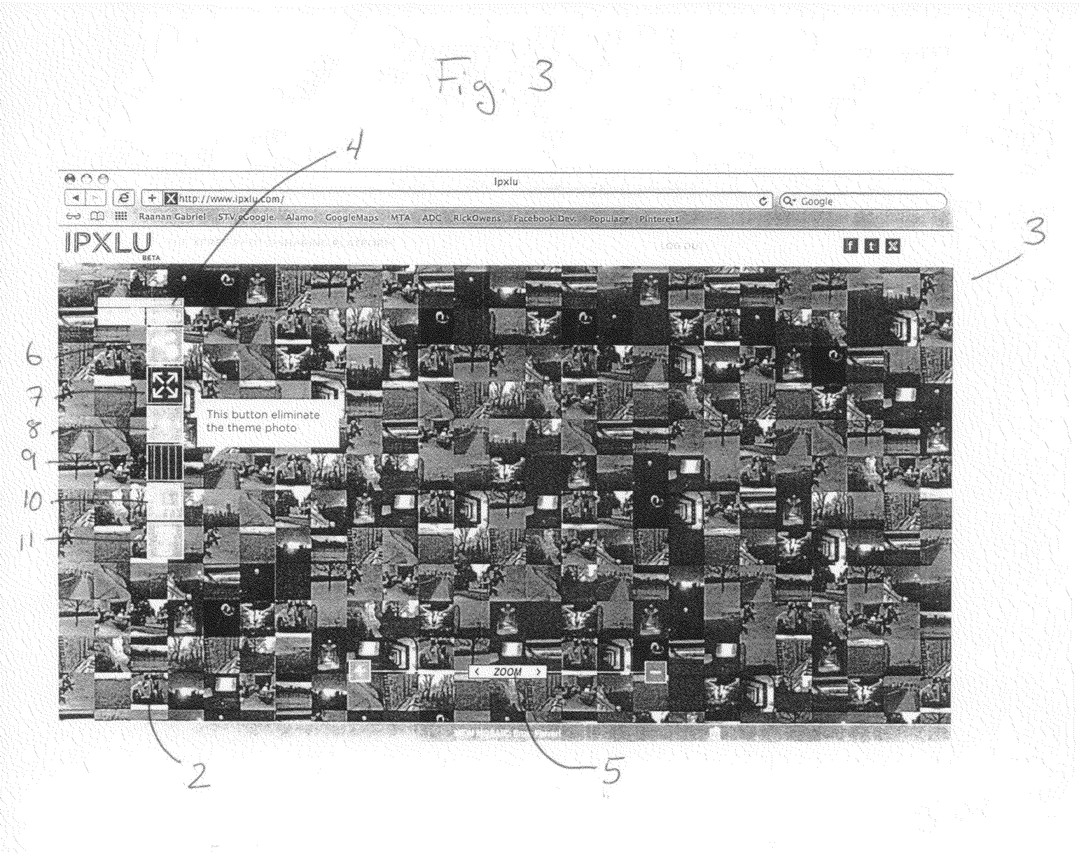

FIG. 3 is the same photographic mosaic as shown in FIG. 2 (Enzo Ferrari in a red Ferrari), displayed in a grid format such that the photographic mosaic no longer resembles the target image and the source images 2 are more easily seen, a menu 4 of virtual buttons for manipulating the displayed images, and a slide control 5 to control the degree of enlargement of the images. The menu contains a virtual button 6 for sharing the photographic mosaic and the source images with other websites, such as Facebook® or Instagram™, a virtual button 7 for enlarging the photographic mosaic to encompass the full screen (as shown), a virtual button 8 for turning on or off a slide show, a virtual button 9 for toggling the grid view on and off, a virtual button 10 for toggling on and off an enlargement mode where an image will be automatically enlarged when the cursor is “moused” over it, and a virtual button 11 for down loading images. As shown here, the full screen enlargement view has been turned on using virtual button 7 and the grid view has been turn on using virtual button 9.

What is claimed:

1. A method of creating a photographic mosaic, wherein a target image is recreated using a computer and at least one source image, comprising the steps of:
a. creating an image library, wherein the image library has at least one image stored therein;
b. selecting one image in the image library to be the target image;
c. selecting one or more images in the image library to be the source images;
d. processing the target image by dividing it into a number of squares or rectangles of equal size;
e. evaluating each square or rectangle of the target image for luminance and assigning a luminance value for each square or rectangle;
f. evaluating the source images for luminance and assigning a luminance value for each image;
g. re-sizing the source images to the size of the squares or rectangles that the target image has been divided into; and
h. creating the photographic mosaic by placing a source image in every square or rectangle of the target image by matching the luminance value of the square or rectangle with the closest luminance value of a source image within a predetermined margin.

2. The method of claim 1, further comprising wherein the squares or rectangles of the target image and the source images are also evaluated for chrominance and a chrominance value is assigned to every square or rectangle of the target image and every source image, and the photographic mosaic is created by placing a source image in every square or rectangle of the target image by matching the luminance value and the chrominance value of the square or rectangle with the closest luminance value and chrominance value of a source image within a predetermined margin.

3. The method of claim 1, further comprising wherein the predetermined margin for matching the luminance values of the squares or rectangles of the target image with those of the source images can be changed using a displayed slide control.

4. The method of claim 2, further comprising wherein the predetermined margin for matching the chrominance values of the squares or rectangles of the target image with those of the source images can be changed using a displayed slide control.

5. The method of claim 1, further comprising wherein the size and number of the squares or rectangles of the target image can be varied.

6. The method of claim 5, further comprising wherein the size and number of the squares or rectangles are varied by a displayed slide control.

7. The method of claim 1, further comprising the step of:
i. creating a file that details the location of each source image within the target image.

8. The method of claim 1, wherein the computer is selected from the group consisting of an individual computer, a network of 2 or more computers, and 2 or more computers connected through an interne connection.

9. The method of claim 1, wherein the number of source images selected to create the target image is 10 or greater.

10. The method of claim 1, wherein the number of source images selected to create the target image is 25 or greater.

11. The method of claim 1, wherein the number of source images selected to create the target image is 50 or greater.

12. The method of claim 1, wherein the number of source images selected to create the target image is 100 or greater.

13. The method of claim 1, wherein the number of source images selected to create the target image is 500 or greater.

14. The method of claim 1, wherein the photographic mosaic is e-mailed to a recipient who can view the photographic mosaic, and can also view the target image and the source images.

15. The method of claim 1, wherein the method of creating the photographic mosaic is part of a social website.

16. The method of claim 1, wherein the photographic mosaic is created for use in or as an advertisement.

17. The method of claim 16, wherein the advertisement is for a business.

18. The method of claim 16, wherein the photographic mosaic is composed of a target image of a specific product and source images of other products.

19. The method of claim 16, wherein the photographic mosaic can be “clicked on” to direct the viewer to a website of the advertiser.

20. The method of claim 1, wherein the photographic mosaic can be “co-created” by two or more users.

21. The method of claim 1, wherein the photographic mosaic can be e-mailed to others, and recipients of the e-mail can “click-on” the photographic mosaic and be directed to a webpage containing the photographic mosaic.

22. The method of claim 1, wherein the photographic mosaic can be “up-load” or “post” to another website, which would allow a viewer of the webpage to “click-on” the photographic mosaic and be thereby directed to a webpage that contains the target and source images.

23. A device for creating a photographic mosaic, wherein a target image is recreated using a at least one source image, comprising:
a computer with software installed, wherein the software creates a photographic mosaic using the method of claim 1.

24. The device of claim 14, wherein the computer is selected from the group consisting of an individual computer, a network of 2 or more computers, and 2 or more computers connected through an Internet connection.

25. A storage device comprising a means for storing software, wherein the device is computer readable and contains software that can create a photographic mosaic using the method of claim 1.

26. The storage device of claim 25, wherein the device is selected from the group consisting of a CD, a DVD, a thumb hard drive, a hard drive, a Solid State Drive (SSD), a floppy disk, 3.5 inch removable diskette, and an encoded microchip.
